(19) United States
(12) Patent Application Publication
(10) Pub. No.: US 2022/0275494 A1
(43) Pub. Date: Sep. 1, 2022

(54) METHODS AND SYSTEMS FOR MEASURING FLATNESS OF ALUMINUM ALLOY SHEET IN A HEAT TREATING FURNACE

(71) Applicant: COMMONWEALTH ROLLED PRODUCTS, INC., NEW YORK, NY (US)

(72) Inventors: Jamaal D. Harris, Philpot, KY (US); Christopher Elwell, Utica, KY (US)

(73) Assignee: COMMONWEALTH ROLLED PRODUCTS, INC., NEW YORK, NY (US)

(21) Appl. No.: 17/625,193

(22) PCT Filed: Jun. 15, 2020
(86) PCT No.: PCT/US2020/037771

§ 371 Date: Jan. 6, 2022

(30) Foreign Application Priority Data
Jul. 8, 2019 (US) 62871371

(51) Int. Cl. C22F 1/04; G01B 11/30

(52) U.S. Cl. CPC C22F 1/04; G01B 11/306

(57) ABSTRACT

The present disclosure relates to a method and system for measuring flatness and degree of sea gull in an aluminum alloy sheet continuously moving in a horizontally floating state through a continuous convection floating furnace. The method and system utilize two or more sensors that take readings indicative of flatness as the aluminum alloy sheet continuously moves through the continuous convection floating furnace. These readings may be compiled into one or more graphics indicative of flatness of the aluminum alloy sheet.

### CROSS-REFERENCE TO RELATED APPLICATION

This application claims the benefit of and priority to U.S. Provisional Application No. 62/871,371 filed Jul. 8, 2019 and titled “Methods and Systems for Measuring Flatness of Aluminum Alloy Sheet in a Heat Treating Furnace,” the content of which is herein incorporated by reference in its entirety.

### FIELD OF THE INVENTION

The invention relates to a method for using laser distance sensors for measuring sheet flatness of aluminum alloy sheet at final thickness as the sheet continuously as it moves in a floating state substantially horizontally through a continuous convection floating heat treating furnace, of a sheet or coil production line, that performs solution heat treating or annealing. The invention relates to using a measurement system and methods for measuring flotation height and degree of sea gull in sheets produced by a the solution heat treating or annealing furnace of a sheet or coil production line, particularly the mist quench section of the furnace.

### BACKGROUND TO THE INVENTION

As will be appreciated herein below, except as otherwise indicated, aluminum alloy designations and temper designations refer to the Aluminum Association designations in Aluminum Standards and Data and the Teal Sheets Registration Record Series as published by the Aluminum Association in 2018 and frequently updated, and well known to the persons skilled in the art. For any description of alloy compositions or preferred alloy compositions, all references to percentages are by weight percent unless otherwise indicated.

Aluminum alloy sheet or coil production comprises several discrete steps. A rolling slab or ingot is subjected to semi-continuous direct chill casting (DC-casting) or electromagnetic casting (EMC-casting), also continuous casting-like belt or roll casting can be applied. The rolling slab or ingot may be preheated at about 500° C. to 580° C. for several hours for homogenization of the microstructure. Then the rolling slab or ingot is hot rolled into hot rolled strip at a gauge of about 3 to 12 mm, the hot rolled strip is typically hot coiled and cooled down to ambient temperature. The hot rolled strip may be cold rolled to final gauge in several passes, optionally an intermediate anneal is applied prior to the cold rolling or during the cold rolling process, and at final gauge the strip is solution heat treated or annealed to adjust the required material properties.

Annealing and solution heat-treatment involve heating and cooling the sheet to specific temperatures and holding at those temperatures for specific durations of time. Solution heat treatment is similar to annealing, but it involves quenching, which is the rapid cooling of the alloy to preserve the distribution of the elements. When used for solution heat treating the heat treatment furnace heats the alloy sheet to a temperature at which a particular constituent will enter into solid solution followed by cooling (quenching) at a rate fast enough to prevent the dissolved constituent from precipitating. After heat treatment, the alloy sheet can be hardened at room temperature (e.g., naturally aged) for a duration, hardened for a duration at a slightly elevated temperature (e.g., artificially aged or pre-aged), and/or otherwise further processed (e.g., cleaned, pretreated, coated, or otherwise processed).

The solution heat treating or annealing can be done either in a continuous heat treating furnace or in a batch type furnace. However, an economical attractive method of producing certain types of aluminum sheet or coil material is by means of continuous solution heat treating or annealing in a continuous heat treating furnace. Here, uncoiled aluminum may be moved in the direction of its length at a controlled line speed through a continuous heat treating furnace and then cooled as it exits the furnace. Thus, at the end of a continuous solution heat treating furnace, the strip material is rapidly cooled or quenched to ambient temperature, for example, by means of forced air cooling and/or spray cooling systems.

To provide longer production runs for continuous annealing or continuous solution heat treating of aluminum sheets, the aluminum sheets are attached end to end in series and fed to the furnace. Typically, a first coil of the aluminum sheet is unrolled to form a sheet and fed to the furnace to be processed and a subsequent coil of the aluminum sheet is unrolled to form the next sheet to be processed. Then, the leading end of this second sheet is attached in series to the trailing end of the previous sheet. Thus, a continuous aluminum sheet is fed to the furnace. The trailing edge of the sheet being processed is typically stopped to connect this trailing edge to the leading edge of the new sheet to be processed to form a joint.

Various types of line equipment have been developed to produce sheets or coils. One such piece of equipment is a continuous convection floating furnace. When utilizing a continuous convection floating furnace, alloy sheet is continuously moved in a floating state substantially horizontally through the continuous convection floating furnace, which is arranged to heat the moving aluminum sheet to a set soaking peak metal temperature.

Published US patent application no. 20170253953 to Meyer et al discloses continuously heat treating by moving heat-treatable 6000-series aluminum alloy sheet substantially horizontally through a convection floating furnace.

Published US patent application no. 20170306466 to Meyer et al discloses continuously moving heat-treatable 7000-series aluminum alloy sheet substantially horizontally through a convection floating furnace.

In a continuous annealing line or continuous solution heat treating line a sheet product having a flat surface is desired. However, the alloy sheet may sometimes exhibit a degree of uneven flotation height, for example sea gulling. Uneven flotation height, for example, sea gulling, is the condition where the alloy sheet cross-section lateral to the direction of travel through the furnace is not flat and horizontal, but rather includes a bump and/or a dip or gulley. The term sea gulling refers to the shape of alloy sheet as it appears in such cross-section lateral to the direction of travel through the furnace. In the sea gull shape this lateral cross section has a center dip and possibly also side dips as for example shown in FIG. 8 resembling a silhouette of a sea gull's wings in flight.

Uneven flotation height and sea gull are undesirable as they result in scratches. For example, in production lines utilizing continuous convection floating furnaces where the alloy sheet floats or is suspended, the moving alloy sheet contact or scrape against portions of the equipment disposed beneath the floating alloy sheet, thereby scratching alloy sheet. Thus, the degree of uneven flotation height or sea gull in a cross-section of an alloy sheet may correlate to the existence of scratches present proximate to the area of that cross-section. Also, the dips or gulleys defined by the uneven flotation or sea gulling exhibited in an alloy sheet will collect water or other fluids sprayed or otherwise applied to the alloy sheet during processing, and such collected water or fluid may result in distortions or buckles in the alloy sheet.

Currently, alloy coils are visually inspected to detect and measure uneven flotation and sea gull. Such visual inspection is expensive in terms of cost and time, and is not always accurate. Accordingly, improved methods and systems for detecting and measuring uneven flotation and sea gull are desirable.

U.S. Pat. No. 3,979,935 discloses a system for detection of roll deflection when a strip of sheet material is passed over the roll. It provides a method of measuring the shape of a moving strip, which method comprises passing the strip, held under tension, over a resilient deflection roll having a resilient outer surface, and measuring the depth of compression of the outer surface of said resilient deflection roll by the strip. The depth of compression is directly related to the stress distribution, which in turn is a measure of the variation in flatness. The depth of compression may be measured by measuring the distance of one or both surfaces of the strip from a fixed datum at the required number of positions across the width of the strip. This may be accomplished by any known distance measuring device, for instance, a triangulation method using either a scanning light source, or a line beam—the light source generally being a laser. This distance measurement can then be translated into a shape signal, which represents the combined effect of internal stress variations and surface buckling caused by the elongation variations.

U.S. Pat. No. 7,164,995 discloses a process for the on-line characterization of a surface in motion, preferably a galvannealed sheet, essentially comprises an industrial microscope associated with a stroboscopic laser illumination device, a positioning assembly, and an assembly for acquiring and processing images. The obtained view fields vary between 125 μm and 2000 μm in width, the spatial resolution is at least 0.5 μm, and the focusing of the system is precise to a micrometer. The images are taken on a product moving at a speed of between 1 m/s and 20 m/s and are frozen by the use of a stroboscopic illumination device with a duration of illumination of at least 10 ns. The obtained images are processed in several steps. A background average level is first of all regularly evaluated in order to be eliminated from each current image. The processed image is then divided into several zones. The sharpness of each zone is evaluated and stored in memory. In the case of a galvannealed steel strip, any object with a center of gravity belonging to a zone in which the sharpness coefficient is too low is eliminated.

U.S. Pat. No. 9,234,746 to Inoue et al discloses an inspection method and inspection apparatus of winding state of sheet member in which laser light is emitted to a sheet member wound on a forming drum in a range which includes the entire width of the sheet member and distance data on a distance to a reflecting surface is obtained, using a two-dimensional laser distance sensor which has a detection range along a drum circumferential direction, while moving either the two-dimensional laser distance sensor or the forming drum in a drum width direction. Further, the positions of width-directional opposite end sections of the sheet member are calculated on the basis of the obtained distance data.

Laser distance sensors use a laser and receiver to measure a target's location without touching ft. Thus, laser distance sensors are designed for non-contact distance measurements. These non-contact sensors are suitable to measure distance of the floating sheet. Measurement principles for a laser distance sensor include triangulation, time-of-flight measurement, pulse-type time-of-flight systems, modulated beam systems and confocal chromatic sensing. Laser distance sensors may also be referred to as “laser distance meters”, “range finders” or “laser range finders.”

Laser triangulation sensors are so named because the sensor enclosure, the emitted laser and the reflected laser light form a triangle. U.S. Pat. No. 6,624,899 to Clark discloses examples of triangulation displacement sensors.

A laser distance sensor using the “time of flight” principle, known either as “time of flight” or “pulse” measurement, works by measuring the time it takes a pulse of laser light to be reflected off a target and returned to the sender. Inside the sensor, a simple computer calculates the distance to target. The distance between the meter and target is given by D=ct/2, where c equals the speed of light and t equals the amount of time for the round trip between meter and target. Modulated beam systems also use the time light takes to travel to a target and back, but the time for a single round trip is not measured directly. Instead, the strength of the laser is rapidly varied to produce a signal that changes over time. The time delay is indirectly measured by comparing the signal from the laser with the delayed signal returning from the target. One common example of this approach is “phase measurement” in which the laser's output is typically sinusoidal and the phase of the outgoing signal is compared with that of the reflected light. U.S. Pat. No. 5,309,212 to Clark discloses modulated beam time of flight measurement instruments.

Another system uses confocal chromatic sensing (CCS). Unlike time-of-flight and triangulation sensors which use lasers, the CCS Prima Confocal sensors use a white light source to accurately measure the distance to surfaces.

None of the above-described references control uneven flotation or sea gulling in a heat treating furnace.

### SUMMARY OF THE INVENTION

Disclosed herein is a method for measuring flatness of a sheet continuously moving in a horizontal floating state through the continuous heat treating furnace. The method includes the step of moving uncoiled aluminum alloy sheet in a horizontal floating state and in a path along a direction of its length, from the entry section to the exit section, and taking measurements indicative of flatness of the aluminum alloy sheet, such as flotation height, as the aluminum alloy sheet moves along the path, using laser distance sensors, typically a plurality of multiple single point lasers, aligned along at least a portion of a width of the aluminum alloy sheet that is perpendicular to the length, in other words aligned lateral to the direction of travel of the floating sheet.

The laser distance sensors, typically a plurality of multiple single point lasers, may be arranged along part or all of the width of the aluminum alloy sheet. Preferably the measurements are done in the cooling station of the production line that cools the heat treated sheet or the measurements are done downstream of the cooling station. The cooling station is within a downstream end of the furnace and/or downstream of the furnace.

Typically, the measurements are performed after the water quench, for example, in either the mist quench section of the furnace or the air quench section of the furnace. Also, the measurements may be similarly performed regardless of whether the sheet is subject to continuous solution heat treating or annealing in a continuous heat treating furnace.

The method may further include a step of modeling flatness of the aluminum alloy sheet utilizing the measurements indicative of flatness, which may be performed in real-time. In some examples, the method further includes displaying at least one graphic representative of flatness that is generated with data obtained from the measurements. The measurements indicative of flatness include measurements by distance measuring laser distance sensors to determine flotation height of the moving sheet. For purposes of this invention, measurements indicative of flatness mean measuring the shape of the surface of the sheet to determine its contours.

In some examples, the step of modeling flatness of the aluminum alloy sheet utilizing the measurements indicative of flatness includes generating at least one flatness map showing flatness of the aluminum alloy sheet along its entire length. In these examples, at least one flatness map may include a two dimensional map of the entire length of the aluminum alloy sheet wherein flatness is represented via colors indicative of distance from the sensors, and/or the at least one flatness map may include a two dimensional plot showing height differential along the entire length of the aluminum alloy. In some examples, this step includes generating a cross sectional representation showing flatness of the aluminum alloy sheet at a particular location along its length.

In some examples, the continuous heat treating furnace includes a plurality of independently controllable fans blowing above and below the aluminum alloy sheet along the path for guiding and maintaining the aluminum alloy sheet in the horizontal floating state along the path as the aluminum alloy sheet horizontally moves in the direction of its length. In these examples, the method may also include the step of controlling speed of the fans based on the measurements indicative of flatness of the aluminum alloy sheet.

### BRIEF DESCRIPTION OF THE FIGURES

FIG. 1 is a schematic representation of the method and the apparatus for a production line employing a continuous convection floating furnace that may incorporate taking measurements indicative of flatness of the floating aluminum alloy sheet according to embodiments of the present invention.

FIG. 2 shows a schematic drawing of a cooling station for cooling the hot moving sheet from the continuous convection floating furnace.

FIG. 3 shows a schematic drawing of a zone of the continuous convection floating furnace.

FIG. 4 schematically shows a portion of the upper nozzle header box to illustrate nozzles that discharge into the space within the elongated heat treatment chamber of the furnace.

FIG. 5 schematically shows a portion of the lower nozzle header box to illustrate nozzles that discharge into the space within the elongated heat treatment chamber of the furnace.

FIG. 6 schematically shows laser distance sensors mounted to a bar mounted to inner walls of the quenching section.

FIG. 7 illustrates a flatness measurement system that may be integrated into one or more aspects of the furnace and quench section described in FIGS. 1-6.

FIGS. 8 and 9 are exemplary graphical outputs indicative of flatness generated with data gathered by the flatness measurement system of FIG. 7 illustrating a sheet exhibiting sea gulling.

FIGS. 10 and 11 are exemplary graphical outputs indicative of a second example of flatness as a crossbow configuration generated with data gathered by the flatness measurement system of FIG. 7 illustrating a sheet that does not exhibit significant sea gulling.

### DETAILED DESCRIPTION

FIG. 1 is a schematic representation of an exemplary continuous heat-treatment furnace (1) that may incorporate the principles of the present disclosure. The continuous heat-treatment furnace (1), sometimes hereinafter referred to as the furnace (1), is just one example of a furnace that can suitably incorporate the principles of the present disclosure. Indeed, many alternative designs and configurations of the furnace (1) may be employed, without departing from the scope of this disclosure.

The continuous heat-treatment furnace (1) is a continuous convection floating furnace arranged to heat the moving aluminum sheet to a set peak metal temperature (T_{PMT}). The furnace (1) has a series of contiguous zones (10) in its chamber (3) arranged to heat the moving sheet (2) such that during normal operation at least one zone (10) heats the moving sheet (2) to a peak metal temperature (T_{PMT}).

The continuous heat-treatment furnace (1) is arranged to transport and to heat-treat uncoiled aluminum sheet (2) moving in the direction of its length along its direction of travel “T”. The aluminum sheet is uncoiled from coil (8). Typically, the aluminum alloy sheet (2) at final gauge has a thickness in the range of 0.3 to 4.5 mm, preferably of 0.7 to 4.5 mm. The sheet width is typically in the range of about 700 to 2700 mm.

FIG. 1 shows the aluminum sheet (2) moving through a first looper accumulator (12) upstream of the furnace (1). FIG. 1 also shows a joiner (16) upstream of looper (12) and a shearing station (18) downstream of second looper accumulator (14). The joiner (16) attaches a leading end of the coil (8) to the trailing end of the sheet (2). For example, joining may be by welding, e.g., by means of friction stir welding.

Then, the moving aluminum sheet (2) passes within the detection range of a line speed sensor (13) which detects the speed of the moving aluminum sheet (2) in its direction of travel “T”.

Then, the moving aluminum sheet (2) is gradually heated up from room temperature (RT) to the set peak metal temperature (T_{PMT}) as it moves through the elongated heat treatment chamber (3) of the continuous heat-treatment furnace (1) having an entry portion (4) and a downstream exit portion (5). The moving aluminum sheet (2) is heated in the chamber (3) of the furnace (1) to a peak metal temperature (T_{PMT}) and soaked for a number of seconds (t_{SOAK}) in the chamber (3) of the furnace (1) at a temperature in the range from the peak metal temperature to the soaking temperature T_{Soak} which is the predetermined desired minimum temperature selected for annealing or solution heat treating. By definition T_{Soak} is lower than peak metal temperature (T_{PMT}).

The moving or traveling aluminum sheet moves substantially horizontally in a floating state through the elongated heat treatment chamber (3) over a length of typically at least about 20 meters, preferably over at least 55 meters.

On leaving the exit portion (5) the moving aluminum sheet (2) is rapidly cooled or quenched in the cooling station (6) (also known as a quenching station) to below about 150° C., e.g. to about room temperature. Various quenching solutions may be applied to the sheet (2) to cool it, including but not limited to water, air, and combinations thereof. The cooling station (6) may thus include forced air cooling systems and/or spray cooling systems, and such cooling or quenching may be utilized regardless of whether the furnace (1) is being used for solution heat treating or annealing. The cooling station (6) may be separate from the furnace (1) and, thus, the cooling station (6) may be controlled independently from the furnace (1); however, the cooling station (6) and the furnace (1) may be configured to operate in tandem. For instance, when the cooling station (6) is outside the furnace (1), the cooling station (6) and furnace (1) can be physically connected.

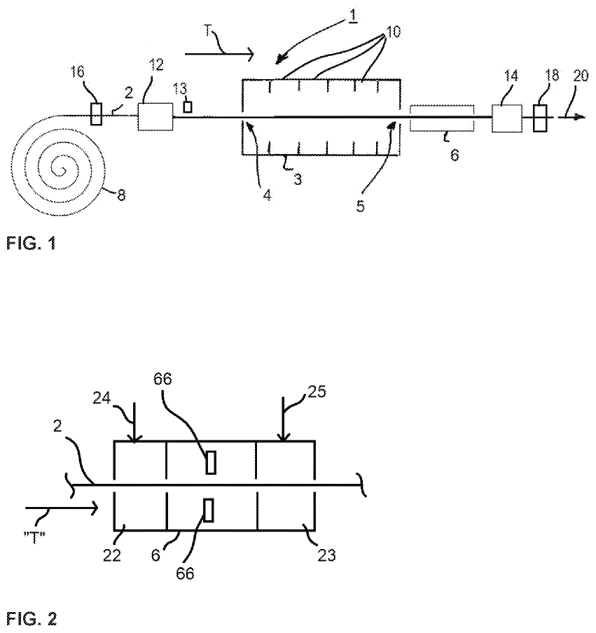

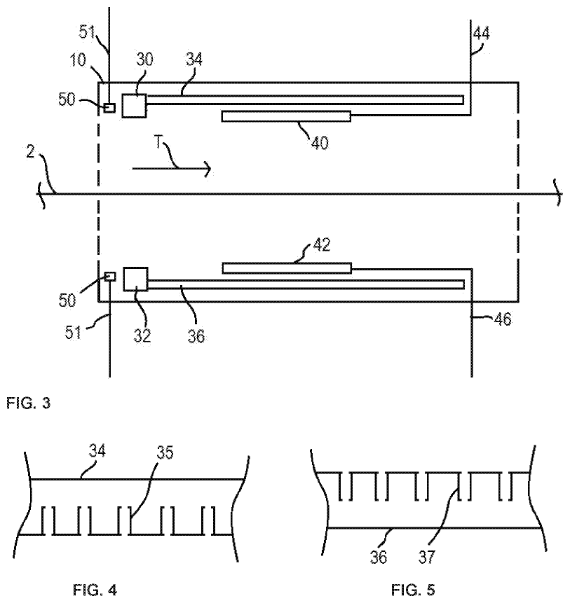

Thus, for example, FIG. 2 shows a schematic drawing of a cooling station for cooling the hot moving sheet from the continuous convection floating furnace (1). FIG. 2 shows the cooling station (6) may have a water cooling station (22) followed by an air cooling station (23), fed by water (24) and air (25), respectively. Although illustrated downstream of the furnace (1), the cooling station (6) may be within a zone (10) at or near the downstream exit portion (5) of the furnace chamber (3). In examples where the cooling station (6) is outside and/or separated from the zone (10), the cooling station (6) may be physically connected to the zone (10), or a gap or space may exist between them.

The laser distance sensors (66) may be located above and/or below the moving sheet (2) floating in the cooling station (6) for measuring flatness in the moving sheet (2). The distance sensors (66) are configured to measure flotation height across all or a portion of the width of the moving sheet (2) and may thus be aligned in a direction transverse to the direction of travel “T” of the sheet (2), as explained in more detail elsewhere in this specification. Each laser distance sensor (66) is set up to record distance from each respective laser to the moving floating strip (2) across all or a portion of the strip's width. Each laser distance sensor (66) is directed to a location on surface of the sheet (2) to measure a respective distance from the laser distance sensor (66) to that location on the surface of the sheet (2). Typically the laser distance sensors (66) are above the moving strip (2). However, the laser distance sensors (66) may be below the moving strip (2). Thus, for example, FIG. 2 shows one of the laser distance sensors (66) above the moving sheet (2) and one of the laser distance sensors (66) below the moving sheet (2). FIG. 2 also shows that these laser distance sensors (66) are between the water cooling station (22) and the air cooling station (23) in the cooling station (6). While the laser distance sensors (66) may be spaced at various distances above or below the moving strip (2), the laser distance sensors (66) are typically placed so that the moving strip (2) remains within the operable range of the laser distance sensors (66) during operation. Typically, the laser distance sensors (66) are placed about 50 to 300 mm, more typically 100 mm to 200 mm, away from the moving strip (2) depending upon space dimensions within the cooling station (6). Also, the moving strip (2) need not be “floating” for the laser distance sensors (66) to measure its flatness.

The laser distance sensors (66) may have various configurations. In the illustrated examples, the laser distance sensors (66) are single point lasers that each measure distance, and the various distance readings may be combined to model or provide information about the shape of the moving strip (2). In these examples, each of the laser distance sensors (66) measures distance at a single point along the width of the moving strip (2) and, therefore, two or more such single point lasers may be utilized to more accurately model flatness of the moving strip (2) across its width and/or obtain information about the shape of the moving strip (2) in more than a single dimension. For example, there may be 4 or more lasers; or 5 or more lasers across its width. For instance, there may be 6 to 20 or 6 to 10 lasers across its width. In other examples, however, two or more of the laser distance sensors (66) may be multi-point lasers or fan/line lasers. In these examples with multi-point lasers or fan/line lasers, a single laser distance sensor (66) would measure flatness at multiple points or along a line, respectively, of the moving strip (2), rather than at an individual point. Thus, for example rather than eight single point lasers across the width of the sheet, possibly two or three fan or line lasers could be employed.

Then the aluminum sheet (2) passes through a second looper accumulator (14) downstream of the furnace (1) and then proceeds to a shearing station (18). The shearing station (18) cuts the heat treated aluminum sheet (2) into product sheets (20). For example, flying shears may cut the heat treated aluminum sheet (2) into product sheets (20).

The first looper accumulator (12) has a series of rollers (not shown) defining a path that can be expanded or contracted to accommodate a temporary stoppage of the trailing end of the sheet. The second looper accumulator (14) would have the same or similar structure as the first looper accumulator (12) to accommodate the aluminum sheet (2) while a portion of aluminum sheet (2) downstream of the second looper accumulator (14) is temporarily stopped or slowed.

FIG. 3 shows a schematic drawing of details of a zone (10) of the continuous convection floating furnace (1). Each zone (10) has at least one fan (30) above the aluminum alloy sheet (2) and at least one fan (32) below the aluminum alloy sheet (2). The fans (30), (32) blow recirculated hot furnace air into respective upper and lower nozzle header boxes (34), (36) which include and feed a respective plurality of nozzles which blow the recirculated hot furnace air onto the sheet (2). The upper nozzle header box (34) blows the recirculated furnace air downwardly onto the sheet (2) to heat and stabilize the moving aluminum alloy sheet (2). The lower nozzle header box (36) blows the recirculated furnace air upwardly onto the sheet (2) to heat, float and stabilize the moving aluminum alloy sheet (2) as it travels in its direction of travel “T”.

Each zone (10) typically has at least one convection heater, for example burner (40), above the sheet (2) and at least one burner (42) below the sheet (2). Typically, the burners (40), (42) are fed with combustible gas, typically natural gas, via lines (44), (46). Each zone (10) also has at least one fresh air feed duct (50) above the sheet (2) and/or below the sheet (2) fed by fresh air intake conduit (51).

FIG. 3 illustrates gas firing burners with multiple air circulation fans. These burners are convective heaters. Preferably, gas firing burners with multiple air circulation fans perform the convective heating. However, various other convective heating means can be applied, e.g., resistance heating, in the continuous heat treatment furnace.

FIG. 4 schematically shows a portion of the upper nozzle header box (34) of FIG. 3 to illustrate nozzles (35) which discharge into the space within the elongated heat treatment chamber (3) of the furnace. In the illustrated example, the nozzles (35) discharge onto an upper surface of the sheet (2). FIG. 5 schematically shows a portion of the lower nozzle header box (36) of FIG. 3 to illustrate nozzles (37) which discharge into the space within the elongated heat treatment chamber (3). In the illustrated example, the nozzles (37) discharge onto a lower surface of the sheet (2). The hot-recirculating furnace air nozzles (35, 37) throughout the furnace length heat the moving strip (2) and keep it afloat on an air cushion. Thus, the strip (2) is traveling in a floating state. Such a furnace (1) is also known as a convection floating furnace. The elimination of mechanical contact at elevated temperature in the heat-treatment furnace translates into a fault-free strip surface. However, mechanical contact, even at un-elevated temperatures, may result in imperfections (e.g., scratches) on the moving strip (2).

The moving sheet (2) enters the entry portion (4) of the elongated heat treatment chamber (3) at a specified line speed and at ambient temperature, and is gradually heated-up while traveling there-through to a pre-set heat treatment temperature. The moving aluminum sheet (2) moves substantially horizontally through the elongated heat treatment chamber (3) of the continuous heat-treatment furnace (1) over various lengths. For example, the sheet (2) may move a length of 40 meters, or 55 meters, or 100 meters, or 120 meters through the elongated heat treatment chamber (3). However, the sheet (2) may move other lengths greater or smaller than the foregoing. For example, the sheet (2) may move about 125 meters through the elongated heat treatment chamber (3). Also, the sheet (2) may travel at various speeds (i.e., line speed) through the continuous heat-treatment furnace (1). For example, the line speed through the furnace (1) may be at least 3 meters/minute, or the line speed may be about 20 to about 140 meters/min. Thereafter, the moving sheet (2) exits leaving the elongated heat treatment chamber (3) at the exit portion (5), at which point the moving sheet (2) is quenched in the cooling station (6). However, as mentioned above, the moving sheet (2) may have contacted portions of the elongated heat treatment chamber (3) during passage therethrough, thereby resulting in imperfections such as scratches.

It is, therefore, desirable that the moving strip (2) be substantially flat, as portions of the strip (2) that are not flat and/or exhibit sea gulling may contact portions of the continuous heat-treatment furnace (1), which in turn imparts scratches in such portions of the strip (2). Also, because portions of the moving strip (2) that are not flat and/or exhibit sea gulling are more susceptible to making undesirable mechanical contact with the continuous heat-treatment furnace (1), it is possible to predict whether any portion(s) of the moving strip (2) has scratches by measuring the flatness of the moving strip (2).

Thus, the invention provides measurement systems and methods for measuring flatness of the strip (2) processed in a continuous annealing line. The system includes two or more laser distance sensors (66) that measure flatness of the moving sheet (2) across all or a portion of the width of the sheet (2) lateral to the direction of travel “T” of the sheet (2). The laser distance sensors (66) continuously measure flatness of the sheet (2) as it moves through the continuous heat-treatment furnace (1). In particular, the laser distance sensors (66) measure the distance to a surface of the moving sheet (2), with a uniform distance measurement representing that the moving sheet (2) is substantially flat and variation in distance measurement indicating that the moving sheet (2) is not flat or exhibits sea gulling at that area.

Various types of laser distance sensors (66) for measuring distance to the sheet (2) may be utilized. For example, the laser distance sensors (66) may include two or more optical displacement measurement lasers such as the optoNCDT 1302 manufactured by Micro-Epsilon Messtechnik GmbH & Co. KG.

In addition, various numbers of the laser distance sensors (66) may be utilized. For example, two or more of the same or different types of laser distance sensors may be utilized. The laser distance sensors could be single point laser sensors. Or the laser distance sensors may be multi-point sensors or line/fan sensors, either of which would be configured to measure flatness at more than a single point on the moving strip. Where multiple laser distance sensors are utilized, the laser distance sensors may be single point sensors that measure at a single point on the moving strip, and/or the sensors may be multi-point and/or line/fan sensors. Typically, a plurality of single point laser distance sensors are placed above the moving strip and arranged along at least a portion of the width of the moving strip, and an individual multi-point or line/fan sensor is located below the moving strip to measure flatness along at least a portion of the width of the moving strip.

The sensors may be arranged at various locations along the line of the continuous heat-treatment furnace (1). The laser distance sensors (66) may be only above the moving sheet (2). The laser distance sensors (66) may be only below the moving sheet (2). The laser distance sensors (66) may be above and below the moving sheet (2).

The laser distance sensors may be arranged within the cooling station (6). FIG. 2 illustrates laser distance sensors (66) above and below the moving sheet (2) in a portion of the cooling station (6) between the water cooling station (22) and the air cooling station (23). However, if desired the laser distance sensors (66) may be arranged in a part of the water quench portion (22) of the cooling station (6) downstream of any major application of the water to the moving sheet (2) such that the applied water would not interfere with the laser operation. Or, the laser distance sensors (66) may also, or instead, be arranged in the air cooling portion (23) of the cooling station (6). In addition to or instead of the cooling station (6), the laser distance sensors (66) may be arranged at one or more other locations along the production line of the continuous heat-treatment furnace (1).

Also, the laser distance sensors (66) are oriented to take readings from various portions of the moving sheet (2). In some examples, the laser distance sensors (66) may be oriented above the moving sheet (2), one shown in FIG. 2, so that they are directed onto an upper surface of the moving sheet (2). However, the laser distance sensors (66) may be differently oriented to take readings from different portions of the moving sheet (2). For example, the laser distance sensors (66) may be oriented beneath the moving sheet (2) so that they take readings from a lower surface thereof. In even other examples, laser distance sensors (66) are oriented above the moving sheet (2) and laser distance sensors (66) sensors are oriented beneath the moving sheet (2).

Moreover, the laser distance sensors (66) may be provided in various arrangements or organizations relative to the moving sheet (2). In some examples, laser distance sensors (66) are arranged along at least 50% of an entire width “W” of the moving sheet (2), at least 80% of the entire width “W” of the moving sheet (2), or along the entire width “W” of the moving sheet (2) as it travels in its direction T through the continuous heat-treatment furnace (1). The width “W” is perpendicular to the direction of travel “T” of the moving sheet (2). Various numbers of laser distance sensors (66) may be utilized. For example, eight laser distance sensors (66) equidistantly spaced across the width of the moving sheet (2) such that the entire width of the moving sheet (2) is measured.

In other examples, laser distance sensors (66) are arranged along a portion of the width “W” of the moving sheet (2) and the readings are then extrapolated for the entire width of the moving sheet (2). For example, four or six laser distance sensors (66) may be positioned along one half or three-quarters, respectively, of the width of the moving sheet (2) and then the readings from that one half width are extrapolated. In the situation where four laser distance sensors (66) are positioned along one half of the width of the moving sheet (2) then the readings from that one half width are extrapolated (i.e., doubled) to model flatness in the other half of the moving sheet (2) without lasers. Thus, an entire width of the moving sheet (2) may be evaluated based on readings from one half the width. In even other examples, different numbers of laser distance sensors (66) are arranged along different portions of the width of the moving sheet (2), with the readings therefrom extrapolated to model flatness along the entire width of the moving sheet (2) or some other desirable portion of the width of the moving sheet (2).

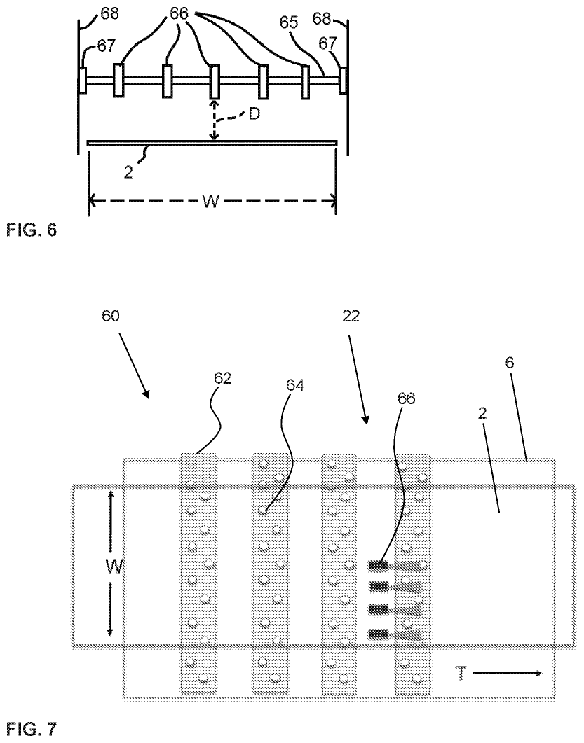

FIG. 6 schematically shows laser distance sensors (66) mounted to a bar (65) mounted to mounting plates (67) mounted to inner walls (68) of the cooling station (6). The laser distance sensors are shown only above the moving sheet (2). FIG. 6 is a front view and illustrates the width “W” of the sheet (2) with the laser distance sensors (66) overhead. The laser distance sensors (66) record respective distances “D” from the laser distance sensors (66) to the strip (2) at various locations along the width “W” of the strip (2).

FIG. 7 illustrates a top view of the cooling station (6) configured with a flatness measurement system (60) including laser distance sensors (66). The flatness measurement system (60) is installed within a water quenching portion (22) of the cooling station (6), where the water quenching portion includes a series of water nozzle supports (62) that each include a plurality of water nozzles (64) configured to spray the moving sheet (2) traveling thereby. Here, the flatness measurement system (60) includes four lasers (66) that are arranged between a pair of the water nozzle supports (62). The four lasers (66) are oriented to measure flatness of one half the width of the moving sheet (2). This flatness measurement system (60) models flatness of the entire width “W” of the moving sheet (2) by extrapolating the flatness measured via the foregoing four lasers (66). In other examples, however, more or less than four lasers (66) are arranged to measure flatness of half the width of the moving sheet (2) or to measure flatness of the entire width or a different fraction of the width.

Also, the laser distance sensors (66) are arranged on a support structure (not illustrated) that may be configured to drop into the cooling station (6) at various locations thereof. In some examples, the water nozzles (64) of the water nozzle supports (62) surrounding the laser distance sensors (66) are deactivated during operation of the flatness measurement system (60). However, in some examples, the laser distance sensors (66) are waterproof and may be located proximate to activated water nozzles (64).

The flatness measurement system (60) thus measures distance from the laser distance sensors (66) to the surface of the moving sheet (2). The flatness measurement system (60) records this measurement data and may manipulate it into one or more user readable schematics. For example, the flatness measurement system (60) may generate plots illustrating flatness of the moving sheet (2) along a specific slice or cross-section and/or a plot illustrating general flatness along the entire length of the moving sheet (2).

### EXAMPLES

### Example 1

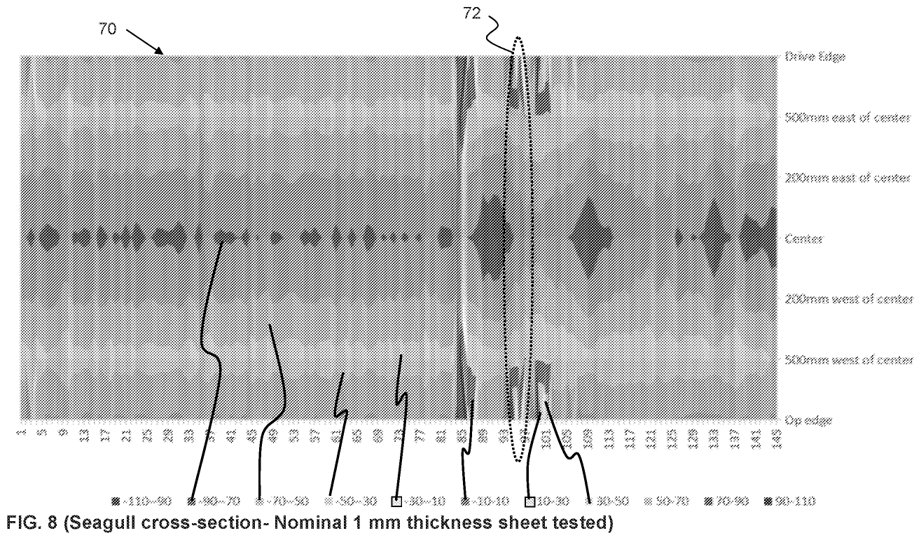

FIG. 8 illustrates an example flatness map (70) generated by the flatness measurement system (60). The flatness map (70) illustrates a top view of the moving sheet (2) and provides indication of flatness along the length of the moving sheet (2). Nominal 1 mm thickness aluminum alloy sheet was tested.

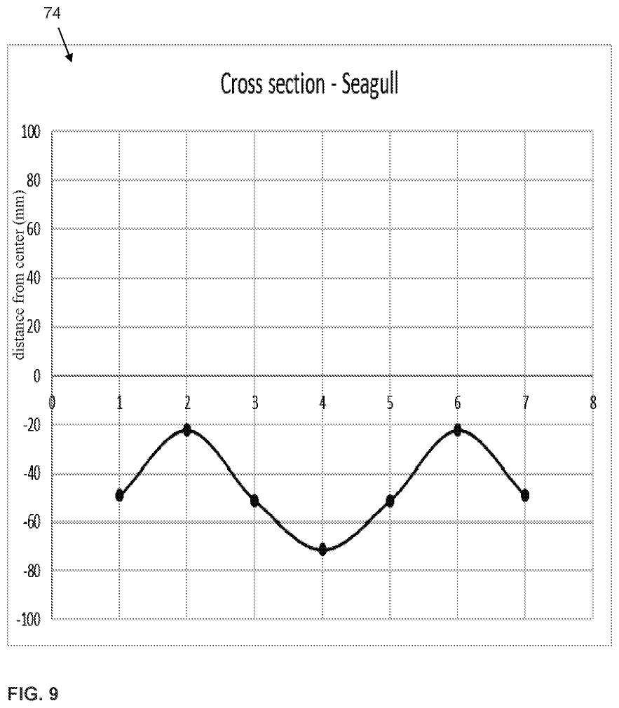

FIG. 9 illustrates an exemplary cross-section map (74) as a region (72) of the moving sheet (2) corresponding to the flatness map (70). In FIG. 9 the Y-axis is the distance from the longitudinal center of sheet travel and respective points along the X-axis represent lasers spaced between about 200 to 300 mm apart in the transverse direction.

Here, the flatness map (70) is color coded where flatness (or non-flatness) is represented via color, where color shades correlate with different distances or ranges of distance measured by the lasers (66). Thus, in FIG. 8 the differences in color or shade represent the distance the sheet surface is above or below the quench center line. For example, where the moving sheet (2) is configured to float beneath the lasers (66) at a certain baseline distance, a light shade may correlate with this certain baseline distance. Here, a darker shade may correlate with distance measurements that are greater than the baseline distance, such that the darker shade is indicative of a gulley or dip in the moving sheet (2) that is lower than the floating height that the moving sheet (2) is designed to float when traveling through the furnace (1) and thus susceptible to scratches. Also, another shade may correlate with distance measurements that are shorter than the baseline such that they represent portions of the moving sheet (2) raised upward from the designed floating height of the moving sheet (2).

The flatness measurement system (60) may permit users to analyse flatness of the moving sheet (2) along various cross sections. For example, a user may review the flatness map (70) to identify a region (72) of the moving sheet (2) that appears to exhibit sea gulling or otherwise be relatively non-flat, and then utilize the flatness measurement system (60) to study the degree of flatness or sea gulling actually encountered (and/or modelled) at the region (72). In one example, the user may select the region (72) exhibiting such sea gulling and direct the flatness measurement system (60) to generate an image of the cross-section of the moving sheet (2) at the region (72) and thereby provide visual representation of the degree of sea gulling at a specific slice of the sheet (2). FIG. 9 illustrates an example cross section (74) of the moving sheet (2) at the region (72) thereof illustrated in FIG. 8.

### Example 2

Moreover, the flatness measurement system (60) may provide other representations of flatness of the moving sheet (2).

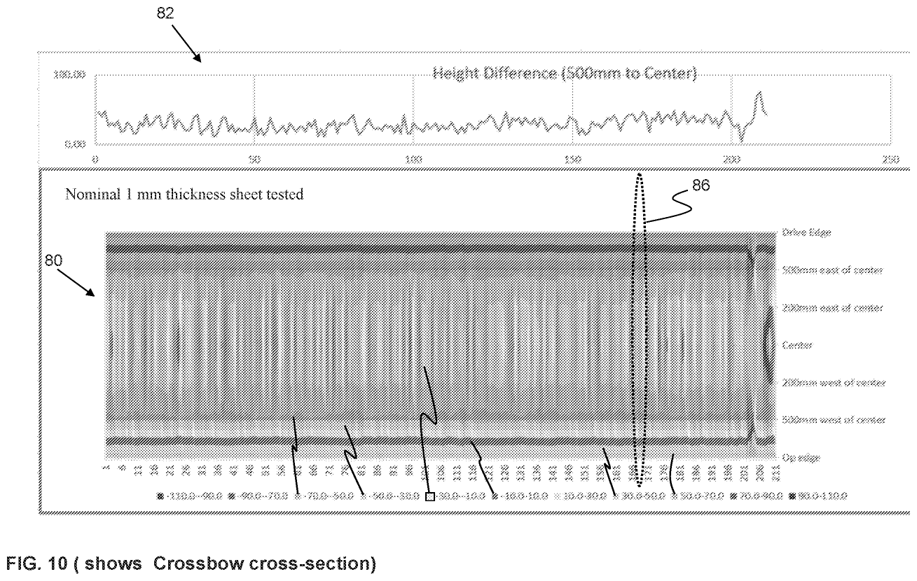

For example, the flatness measurement system (60) may generate a plot representing a side view of the moving sheet (2) that illustrates the average height difference along a length of the moving sheet (2). FIG. 10 illustrates an example flatness map (80) and corresponding height differential profile map (82) generated by the flatness measurement system (60). Nominal 1 mm thickness aluminum alloy sheet was tested.

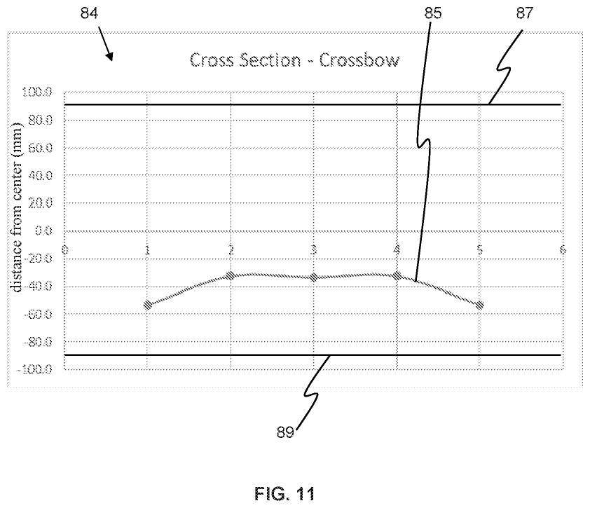

FIG. 11 illustrates an exemplary cross-section map (84) as a slice (86) of the moving sheet (2) corresponding to the flatness map (80) and height differential profile map (82). FIG. 11 shows a plot line 85 representing the cross-section of the sheet, and shows plot lines 87, 89 representing the maximum distance of permitted travel above and below the centreline of longitudinal travel of the sheet. In FIG. 11 the Y-axis is the distance from the longitudinal center of sheet travel and respective points along the X-axis represent lasers spaced between about 200 to 300 mm apart in the transverse direction.

A user or operator may select the slice (86) in either or both of the flatness map (80) and/or height differential profile map (82) graphics shown in FIG. 10, and then the system will generate the cross-section map corresponding therewith such that the flatness at each length of the moving sheet (2) may be evaluated. Thus, FIG. 11 may be generated in response to a user selecting or identifying a certain cross-section or slice in the flatness map (80) and/or height differential profile map (82) of FIG. 10.

The flatness map (80) of FIG. 10 is similar to the flatness map (70) of FIG. 8, except that flatness map (80) illustrates an exemplary moving sheet (2) that does not exhibit sea gulling to the extent as exemplified in FIGS. 8-9. Rather, the moving sheet (2) is illustrated as generally flat (FIG. 10) with the profile along its length exhibiting a cross bow shape as exemplified by the cross-section map (84) of FIG. 11. This shows flatness of the moving sheet (2) at the slice (86) which may correspond with a certain cross section of the moving sheet (2) specified by a user in the flatness map (80) and/or height differential profile map (82) of FIG. 10.

Thus, the flatness measurement system (60) may be utilized to analyse the flatness of the moving sheet (2) processed by the furnace (1).

Modifying Operation Based on Flatness Measurements

Personnel may utilize the flatness measurement system (60) to identify whether the moving sheet (2) is suitable for subsequent use or whether it needs further processing.

For example, an operator of the furnace (1) may utilize the flatness measurement system (60) in real time during processing of the moving sheet (2) and, upon encountering sea gulling as exemplified in FIGS. 8 and 9, may temporarily halt operation as needed to address the sea gulling. For example, the operator may temporarily halt operation of the furnace (1) and change or modify one or more parameters to remediate sea gulling, so that the flatness measurement system (60) outputs visual feedback as exemplified in FIGS. 10 and 11. In other examples, however, the flatness measurement system (60) creates a data file for each moving sheet (2) processed into a roll by the furnace, which the operator may later analyze after processing as part of an inspection process to identify scratches.

For example, where the furnace (1) includes top and/or bottom fans configured to “float” the moving sheet (2) as it travels there through, the furnace automatically uses distance measurements from the laser distance sensors (66) to control the top and/or bottoms fans. Thus, when the flatness measurement system (60) determines that a portion of the moving sheet (2) exhibits sea gulling as illustrated in FIG. 9, it may automatically increase the speed of a fan located beneath the moving sheet (2) at that location to attempt to push the moving sheet (2) upward so that it more closely resembles FIG. 11 which shows a crossbow contour.

The flatness measurement system (60) may also instruct one or more fans downstream to apply increased upwardly directed air pressure to correct the sea gulling. In such examples, upon determining that the sea gulled portion of the moving sheet (2) is floating above them, the flatness measurement system (60) may trigger the downstream fans to apply corrective upwardly directed air flow, such that corrective air flow is only applied along portions of the moving sheet (2) exhibiting sea gulling. Also, additional arrays of lasers (66) may be provided upstream or downstream to provide additional feedback for controlling the fans or other devices utilized to correct sea gulling.

The flatness measurement system (60) accurately and continuously models sea gulling within a moving sheet (2), and this feedback may be utilized to identify rolls of sheets (2) having undesirable scratches in real time or after processing and, in some examples, actively control system parameters utilized to float the moving sheet (2) so that it does not exhibit sea gulling.

Also disclosed herein is a method for measuring flatness of the moving sheet (2) continuously moving through the continuous heat treating furnace (1). The method includes the step of moving uncoiled aluminum alloy sheet in a horizontal floating state and in a path along a direction of its length, from the entry section to the exit section, and taking measurements indicative of flatness of the aluminum alloy sheet as the aluminum alloy sheet moves along the path using two or more laser distance measuring sensors aligned along at least a portion of a width of the aluminum alloy sheet that is perpendicular to the length. As mentioned, in some examples the two or more sensors are arranged along one half of the width of the aluminum alloy sheet. In other examples, the two or more sensors are arranged along the entire width of the aluminum alloy sheet. The method may further include a step of modeling flatness of the aluminum alloy sheet utilizing the measurements indicative of flatness, which may be performed in real-time. In some examples, the method further includes displaying on a display at least one graphic representative of flatness that is generated with data obtained from the measurements.

In some examples, the step of modeling flatness of the aluminum alloy sheet utilizing the measurements indicative of flatness includes generating at least one flatness map showing flatness of the aluminum alloy sheet along its entire length. In these examples, at least one flatness map may include a two dimensional map of the entire length of the aluminum alloy sheet wherein flatness is represented via colors indicative of distance from the sensors, and/or at least one flatness map may include a two dimensional plot showing height differential along the entire length of the aluminum alloy. In some examples, this step includes generating a cross sectional representation showing flatness of the aluminum alloy sheet at a particular location along its length.

Where the continuous heat treating furnace includes a plurality of independently controllable fans blowing above and below the aluminum alloy sheet along the path for guiding and maintaining the aluminum alloy sheet in the horizontal floating state along the path as the aluminum alloy sheet horizontally moves in the direction of its length, the method may also include the step of controlling the fans based on the measurements indicative of flatness of the aluminum alloy sheet.

Therefore, the disclosed systems and methods are well adapted to attain the ends and advantages mentioned as well as those that are inherent therein. The teachings of the present disclosure may be modified and practiced in different but equivalent manners apparent to those skilled in the art of having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure.

The systems and methods illustratively disclosed herein may suitably be practiced in the absence of any element that is not specifically disclosed herein and/or any optional element disclosed herein.

While compositions and methods are described in terms of “comprising,” “containing,” or “including” various components or steps, the compositions and methods can also “consist essentially of” or “consist of” the various components and steps.

All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

The use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

1. A method for continuously measuring flatness of aluminum alloy sheet, the method comprising:
moving aluminum alloy sheet in a horizontal floating state in a path along a direction of its length through a continuous heat treating furnace and a cooling station, wherein the heat treating furnace has an entry section and an exit section,
wherein the aluminum alloy sheet moves, in the horizontal floating state in the path along the direction of its length, from the heat treating furnace entry section to the heat treating furnace exit section and passes from the heat treating furnace exit section to the cooling station,
wherein the continuous heat treating furnace heats the moving aluminum alloy sheet,
wherein the cooling station cools the moving aluminum alloy sheet; and
taking measurements indicative of flatness of the aluminum alloy sheet to determine contour of a surface of the aluminum alloy sheet as the aluminum alloy sheet moves in the horizontal floating state along the path within the cooling station using two or more laser distance sensors aligned along at least a portion of a width of the aluminum alloy sheet that is perpendicular to length of the aluminum alloy sheet, the lasers being directed at the sheet surface.

2. The method of claim 1, wherein there are four or more laser distance sensors, wherein the laser distance sensors are arranged along at least one half of the width of the aluminum alloy sheet.

3. The method of claim 1, wherein the laser distance sensors are arranged along at least 80% of the entire width of the aluminum alloy sheet.

4. The method of claim 1, wherein the laser distance sensors are arranged within an air quenching portion of the cooling station.

5. The method of claim 1, wherein the laser distance sensors are arranged within a mist quenching portion of the cooling station.

6. The method of claim 5, wherein the laser distance sensors are arranged along one half of the width of the aluminum alloy sheet.

7. The method of claim 5, wherein the laser distance sensors are arranged along at least 80% of the width of the aluminum alloy sheet.

8. The method of claim 1, wherein the laser distance sensors are arranged above the aluminum alloy sheet.

9. The method of claim 1, wherein the laser distance sensors are arranged below the aluminum alloy sheet.

10. The method of claim 1, wherein a first plurality of the laser distance sensors is arranged above the aluminum alloy sheet and a second plurality of the laser distance sensors is arranged below the aluminum alloy sheet.

11. The method of claim 1, further comprising:
modeling flatness of the aluminum alloy sheet utilizing the measurements indicative of flatness.

12. The method of claim 11, wherein modeling flatness of the aluminum alloy sheet utilizing the measurements indicative of flatness includes:
generating at least one flatness map showing flatness of the aluminum alloy sheet along its entire length.

13. The method of claim 12, wherein the at least one flatness map includes a two dimensional map of the entire length of the aluminum alloy sheet wherein flatness is represented via colors indicative of distance from the laser distance sensors.

14. The method of claim 12, wherein the at least one flatness map includes a two dimensional plot showing height differential along the entire length of the aluminum alloy.

15. The method of claim 11, wherein modeling flatness of the aluminum alloy sheet utilizing the measurements indicative of flatness includes:
generating a cross sectional representation showing flatness of the aluminum alloy sheet at a particular location along its length.

16. The method of claim 11, wherein the laser distance sensors are arranged along a portion of the width of the aluminum alloy sheet that is less than an entirety of the width, and modeling flatness of the aluminum alloy sheet utilizing the measurements indicative of flatness includes:
extrapolating measurements from the portion of the width to the entirety of the width, to generate at least one flatness map showing flatness of the aluminum alloy sheet along its entire width.

17. The method of claim 11, wherein the modeling flatness of the aluminum alloy sheet utilizing the measurements occurs in real-time.

18. The method of claim 17, further comprising displaying on a display at least one graphic representative of flatness that is generated with data obtained from the measurements.

19. The method of claim 1, wherein the laser distance sensors comprise optical displacement measurement lasers.

20. The method of claim 1, wherein the continuous heat treating furnace includes a plurality of independently controllable fans blowing above and below the aluminum alloy sheet along the path for guiding and maintaining the aluminum alloy sheet in the horizontal floating state along the path as the aluminum alloy sheet horizontally moves in the direction of its length, the method further comprising:
controlling the fans based on the measurements indicative of flatness of the aluminum alloy sheet.

21. The method of claim 1, wherein the measurements indicative of flatness comprise flotation height and degree of seagull, and combinations of the same.

22. A system for continuously measuring flatness of an aluminum alloy sheet moving in a horizontal floating state in a path along a direction of the sheet's length, comprising:
a continuous heat treating furnace for heating the moving aluminum alloy sheet, wherein the heat treating furnace has an entry section and an exit section for the aluminum sheet to enter and exit, respectively, as the aluminum sheet moves in the horizontal floating state therethrough in the path along a direction of the sheet's length from the heat treating furnace entry section to the heat treating furnace exit section and passes from the heat treating furnace exit section to a cooling station, wherein the cooling station is located to receive the aluminum sheet from the furnace and wherein the cooling station cools the moving aluminum alloy sheet as the aluminum sheet moves in the horizontal floating state therethrough in the path along a direction of the sheet's length; and
laser distance sensors aligned along at least a portion of a width of the aluminum alloy sheet that is perpendicular to length of the aluminum alloy sheet, the laser distance sensors for taking measurements indicative of flatness of the aluminum alloy sheet as the aluminum alloy sheet moves in the horizontal floating state along the path within the cooling station;
wherein the measurements indicative of flatness comprise flotation height.
